(19) United States
(12) Patent Application Publication
(10) Pub. No.: US 2014/0122015 A1
(43) Pub. Date: May 1, 2014

(54) ATTITUDE ESTIMATION METHOD AND APPARATUS

(71) Applicant: Yamaha Corporation, Hamamatsu-Shi (JP)

(72) Inventor: IBUKI HANDA, Hamamatsu-shi (JP)

(73) Assignee: Yamaha Corporation, Hamamatsu-Shi (JP)

(21) Appl. No.: 14/066,148

(22) Filed: Oct. 29, 2013

(30) Foreign Application Priority Data
Oct. 30, 2012 (JP) 2012-239131

(51) Int. Cl. G01C 21/10

(52) U.S. Cl. CPC G01C 21/10
USPC 702/141; 702/150

(57) ABSTRACT

From a first estimation value of attitude of equipment at a first time, a second estimation value of attitude of the equipment at a second time is derived. For this purpose, a predicted value of the attitude at the second time is generated by applying the first estimation value to a state transition model indicating transition of attitude of the equipment. Then, a difference between the predicted value of the attitude and a true value of the attitude of the equipment is calculated based on data outputted from a sensor in the equipment to thereby generate an estimated attitude error between the predicted attitude and true attitude of the equipment. Further, a specific attitude component is extracted from a plurality of attitude components of the estimated attitude error. Lastly, the second estimation value is calculated based on the predicted value of the attitude and the specific attitude component.

### BACKGROUND OF THE INVENTION

1. Technical Field of the Invention

The present invention relates to an attitude estimation method and apparatus.

2. Description of the Related Art

In a case in which a state of a dynamic system, such as an attitude of an object, is estimated, it is possible to estimate a correct value within a shorter period of time through integration and calculation of output results of a plurality of sensors, such as a geomagnetic sensor, an acceleration sensor, and an angular velocity sensor, for measuring different kinds of physical quantities than through calculation based on an output result of one kind of sensor.

A method using a Kalman filter is well known as a method of integrating outputs from a plurality of sensors for measuring different kinds of physical quantities to estimate a state of a dynamic system. For example, non-patent literature 1 discloses an attitude estimation apparatus that integrates outputs from a three axis geomagnetic sensor, a three axis angular velocity sensor, and a three axis acceleration sensor using a sigma point Kalman filter, which is a kind of nonlinear Kalman filter, to estimate an attitude.
[Non-Patent Literature 1] J. L. Crassidis, and F. L. Markley, “Unscented Filtering for Spacecraft Attitude Estimation,” Journal of Guidance, Control and Dynamics, 26 (2003), pp. 536-542

A sensor, such as a geomagnetic sensor or an acceleration sensor, may detect a noise component other than signal components to be detected. For example, even in a case in which acceleration of gravity is to be detected, an acceleration sensor detects an acceleration component related to vibration other than acceleration of gravity if the acceleration sensor vibrates. In addition, a geomagnetic sensor, which is configured to detect geomagnetism, detects a magnetic component other than the geomagnetism if an object generating a magnetic field is present in the vicinity of the geomagnetic sensor.

In a case in which a sensor used in an attitude estimation apparatus detects a noise component other than a signal component to be detected, the attitude estimation apparatus is affected by the noise with the result that the attitude estimation apparatus may estimate an attitude greatly deviating from an actual attitude.

### SUMMARY OF THE INVENTION

The present invention has been made in view of the above problem, and it is an object of the present invention to provide an attitude estimation method that is capable of preventing estimation of an attitude deviating from an actual attitude even in a case in which a sensor used in an attitude estimation apparatus detects a noise component other than a signal component to be detected.

In order to solve the above problems, the present invention provides a method of estimating attitude of equipment having a plurality of sensors including an acceleration sensor, the method comprising: generating a first estimation value of the attitude of the equipment at a first time; determining whether the attitude of the equipment is stable or not, based on acceleration data outputted from the acceleration sensor; predicting the attitude of the equipment at a second time after a predetermined period from the first time to thereby generate a predicted value of the attitude, by applying the first estimation value to a state transition model indicating transition of the attitude of the equipment; estimating a difference between the predicted value of the attitude and a true value of the attitude of the equipment based on data outputted from at least one sensor included in the plurality of the sensors to thereby generate an estimated attitude error between the predicted attitude and true attitude of the equipment; calculating a second estimation value of the attitude of the equipment at the second time based on the predicted value of the attitude and the estimated attitude error when the attitude of the equipment is determined to be stable; extracting a specific attitude component from a plurality of attitude components of the estimated attitude error when the attitude of the equipment is determined to be not stable; and calculating a second estimation value of the attitude of the equipment at the second time based on the predicted value of the attitude and the specific attitude component extracted from the estimated attitude error when the attitude of the equipment is determined to be not stable.

In a preferable form, the plurality of attitude components of the estimated attitude error comprise a tilt component representing a tilt from an axis extending in a direction of gravity acceleration and a rotation component around the axis, and the specific attitude component is the rotation component obtained by removing the tilt component from the estimated attitude error.

In a preferable form, the plurality of attitude components are obtained by changing reference attitude of the equipment by the estimated attitude error.

In a preferable form, the attitude of the equipment is represented by quaternion.

In a preferable form, the plurality of sensors further include a magnetic sensor and an angular velocity sensor, and the method further comprises: generating an input observation value including, as its elements, magnetic data outputted from the magnetic sensor and acceleration data outputted from the acceleration sensor when the attitude of the equipment is determined to be stable; and generating an input observation value including, as its elements, magnetic data outputted from the magnetic sensor and precluding acceleration data outputted from the acceleration sensor when the attitude of the equipment is determined to be not stable. Then, the attitude of the equipment at the second time is predicted by applying the first estimation value at the first time and angular velocity data outputted from the angular velocity sensor to the state transition model, and the estimated attitude error is generated by: applying the predicted value of the attitude at the second time to an observation model presenting relation between elements of the observation value and a value of the attitude so as to estimate the elements of the observation value at the second time, thereby generating an estimated observation value having the estimated elements; calculating difference between the estimated observation value and the input observation value to generate an observation residual representing the calculated difference; and generating the estimated attitude error based on the observation residual and the predicted value of the attitude of the equipment.

In a preferable form, the attitude of the equipment is determined to be stable in case that an absolute value of difference between a magnitude of the acceleration data outputted from the acceleration sensor and a magnitude of the gravity acceleration is not more than a predetermined value.

The present invention further provides a method of estimating attitude of equipment having a sensor, comprising: generating a first estimation value of the attitude of the equipment at a first time; predicting the attitude of the equipment at a second time after a predetermined period from the first time to thereby generate a predicted value of the attitude, by applying the first estimation value to a state transition model indicating transition of the attitude of the equipment; estimating a difference between the predicted value of the attitude and a true value of the attitude of the equipment based on data outputted from the sensor to thereby generate an estimated attitude error between the predicted attitude and true attitude of the equipment; extracting a specific attitude component from a plurality of attitude components of the estimated attitude error; and calculating a second estimation value of the attitude of the equipment at the second time based on the predicted value of the attitude and the specific attitude component extracted from the estimated attitude error.

In a preferable form, the sensor comprises a magnetic sensor for outputting magnetic data representing geomagnetism.

In a preferable form, the plurality of attitude components of the estimated attitude error comprises a tilt component representing a tilt from an axis extending in a direction of gravity acceleration and a rotation component around the axis, and the specific attitude component is the rotation component obtained by removing the tilt component from the estimated attitude error.

In a preferable form, the plurality of attitude components are obtained by changing reference attitude of the equipment by the estimated attitude error.

The present invention further provides an apparatus for estimating attitude of equipment having a plurality of sensors including an acceleration sensor, the apparatus comprising one or more processor configured to: generate a first estimation value of the attitude of the equipment at a first time; determine whether the attitude of the equipment is stable or not, based on acceleration data outputted from the acceleration sensor; predict the attitude of the equipment at a second time after a predetermined period from the first time to thereby generate a predicted value of the attitude, by applying the first estimation value to a state transition model indicating transition of the attitude of the equipment; estimate a difference between the predicted value of the attitude and a true value of the attitude of the equipment based on data outputted from at least one sensor included in the plurality of the sensors to thereby generate an estimated attitude error between the predicted attitude and true attitude of the equipment; calculate a second estimation value of the attitude of the equipment at the second time based on the predicted value of the attitude and the estimated attitude error when the attitude of the equipment is determined to be stable; extract a specific attitude component from a plurality of attitude components of the estimated attitude error when the attitude of the equipment is determined to be not stable; and calculate a second estimation value of the attitude of the equipment at the second time based on the predicted value of the attitude and the specific attitude component extracted from the estimated attitude error when the attitude of the equipment is determined to be not stable.

The present invention further provides an apparatus for estimating attitude of equipment having a sensor, the apparatus comprising one or more processor configured to: generate a first estimation value of the attitude of the equipment at a first time; predict the attitude of the equipment at a second time after a predetermined period from the first time to thereby generate a predicted value of the attitude, by applying the first estimation value to a state transition model indicating transition of the attitude of the equipment; estimate a difference between the predicted value of the attitude and a true value of the attitude of the equipment based on data outputted from the sensor to thereby generate an estimated attitude error between the predicted attitude and true attitude of the equipment; extract a specific attitude component from a plurality of attitude components of the estimated attitude error; and calculate a second estimation value of the attitude of the equipment at the second time based on the predicted value of the attitude and the specific attitude component extracted from the estimated attitude error.

In addition, the present invention provides a program of a computer for controlling an attitude estimation apparatus, provided in equipment having a plurality of sensors including a three-dimensional acceleration sensor for detecting accelerations in three directions and sequentially outputting detected results as vector data in a three axis coordinate system, for estimating an attitude of the equipment, wherein the program enables the computer to function as: a determination unit for determining whether motion of the equipment is stable or not based on output values from the three-dimensional acceleration sensor; and a Kalman filter unit for calculating an estimated value of an attitude at a time after the lapse of unit time from a certain time from an estimated value of an attitude at the certain time based on a determined result of the determination unit and an observed value vector having output values from at least a portion of the sensors as elements. The program enables the Kalman filter unit to function as: a state transition model unit for estimating an attitude at a time after the lapse of unit time from a certain time from an estimated value of the attitude at the certain time using a state transition model indicating time-based change of the attitude of the equipment; an estimated value correction unit for generating an estimated attitude error, which is a value obtained by estimating a difference between a predicted result of the state transition model unit and an actual attitude at the time after the lapse of unit time from the certain time, based on the predicted result of the state transition model unit and the observed value vector; and an attitude update unit for calculating an estimated value of the attitude after the lapse of unit time from the certain time based on the estimated attitude error and a predicted result of the state transition model unit in a case in which the determined result of the determination unit is positive, and for calculating an estimated value of the attitude after the lapse of unit time from the certain time based on an extracted estimated attitude error obtained by extracting a rotation component having an axis extending in a direction of acceleration of gravity as a rotational axis from the estimated attitude error and the predicted result of the state transition model unit in a case in which the determined result of the determination unit is negative.

### BRIEF DESCRIPTION OF THE DRAWINGS

FIG. 1 is a block diagram showing a configuration of portable equipment according to an embodiment of the present invention.

FIG. 2 is a perspective view showing the external appearance of the portable equipment according to the embodiment of the present invention.

FIG. 3 is a block diagram showing a function of an attitude estimation unit according to an embodiment of the present invention.

FIG. 4 is a block diagram showing a function of a Kalman filter unit according to an embodiment of the present invention.

FIG. 5 is a view illustrating a function of an attitude update unit according to an embodiment of the present invention.

### DETAILED DESCRIPTION OF THE INVENTION

### A. Embodiment

An embodiment of the present invention will be described with reference to the accompanying drawings.

<1. Configuration of Equipment and Configuration of Software>

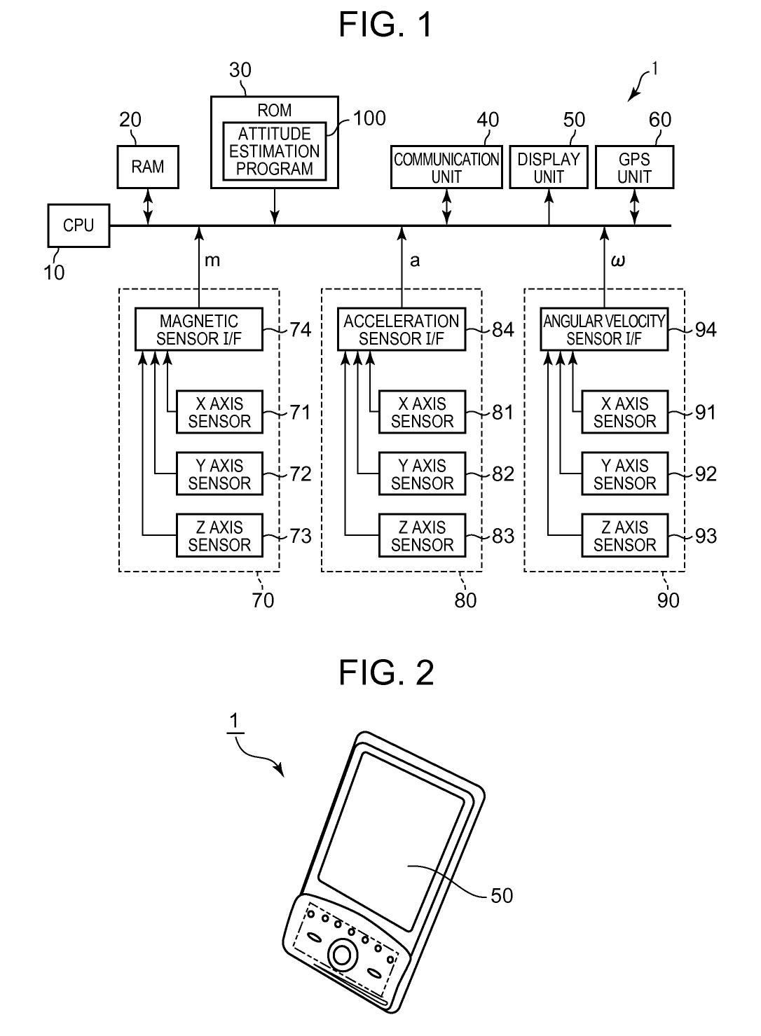

FIG. 1 is a block diagram of portable equipment according to an embodiment of the present invention and FIG. 2 is a perspective view showing the external appearance of the portable equipment. The portable equipment 1 has a function for rotating a picture, such as a map, displayed on a screen (a display unit 50, which will hereinafter be described) in response to the posture of the portable equipment 1 such that azimuth displayed by the picture follows that of a real space. This function is realized by performing a Kalman filter calculation based on outputs of various kinds of sensors to estimate the attitude of the portable equipment 1.

The portable equipment 1 includes a CPU 10 connected to various kinds of configuration elements via buses for controlling the entirety of an attitude estimation apparatus, a RAM (accumulation unit) 20 functioning as a work area of the CPU 10, a ROM 30 for storing various kinds of programs, such as an attitude estimation program 100, and data, a communication unit 40 for performing communication, a display unit 50 for displaying a picture, and a GPS unit 60.

In addition, the portable equipment 1 includes a three-dimensional magnetic sensor 70 for detecting magnetism, such as geomagnetism, to output magnetic data m, a three-dimensional acceleration sensor 80 for detecting acceleration to output acceleration data a, and a three-dimensional angular velocity sensor 90 for detecting angular velocity to output angular velocity data co.

The display unit 50 displays a picture, such as an arrow indicating an orientation, based on an estimated value of an attitude q of portable equipment 1 estimated by the CPU 10 executing the attitude estimation program 100.

The GPS unit 60 receives a signal from a GPS satellite to generate position information (latitude and longitude) of the portable equipment 1.

The three-dimensional magnetic sensor 70 includes an X axis magnetic sensor 71, a Y axis magnetic sensor 72, and a Z axis magnetic sensor 73. Each of the sensors may be configured using a magnetic impedance device (MI device), a magnetic resistance effect device (MR device), etc. A magnetic sensor I/F 74 converts analog output signals from the X axis magnetic sensor 71, the Y axis magnetic sensor 72, and the Z axis magnetic sensor 73 into digital signals to output magnetic data m. More specifically, in a coordinate system fixed to the portable equipment 1, the magnetic data m are vector data indicating an output value from the X axis magnetic sensor 71 as an x axis component, an output value from the Y axis magnetic sensor 72 as a y axis component, and an output value from the Z axis magnetic sensor 73 as a z axis component.

Meanwhile, geomagnetism B_{g} is included in the magnetic data m detected by the three-dimensional magnetic sensor 70.

Generally, geomagnetism B_{g} is a magnetic field having a horizontal component directed to a north magnetic pole and a perpendicular component decided by a magnetic dip. In a coordinate system fixed to the ground, the geomagnetism B_{g} is represented as a vector ^{G}B_{g} having a uniform direction and magnitude (Meanwhile, a superscript G attached to the left upper part of a symbol of the vector means that the vector is represented in the coordinate system fixed to the ground). That is, in the coordinate system fixed to the portable equipment 1, the geomagnetism B_{g} is represented as a vector ^{S}B_{g}(q) having a direction varying according to the attitude q of the portable equipment 1 and a uniform magnitude (Meanwhile, a superscript S attached to the left upper part of a symbol of the vector means that the vector is represented in the coordinate system fixed to the portable equipment 1). Consequently, it is possible to obtain the attitude q of the portable equipment 1 by calculating the vector ^{S}B_{g}(q) indicating the geomagnetism B_{g} in the coordinate system fixed to the portable equipment 1.

However, in a case in which an object, such as a speaker, generating a magnetic field and objects, such as various kinds of metals, exhibiting magnetism are present in the vicinity of the portable equipment 1, the portable equipment 1 may be affected by magnetic fields (noise) from these objects. In this case, a value indicating the magnetic data m is a value obtained by superimposing the magnetic fields generated by the objects present in the vicinity of the portable equipment 1 on the geomagnetism B_{g}. That is, when an object generating a magnetic field is present in the vicinity of the portable equipment 1, it may be difficult to correctly obtain a direction indicating the geomagnetism B_{g} (i.e. a direction of the vector ^{S}B_{g}(q)) based on the magnetic data m. In this case, it is not possible to correctly obtain the attitude q of the portable equipment 1 based on the magnetic data m.

The three-dimensional acceleration sensor 80 includes an X axis acceleration sensor 81, a Y axis acceleration sensor 82, and a Z axis acceleration sensor 83. Each of the sensors may be a piezo resistance type sensor, a capacitive type sensor, or a detection type sensor, such as a heat detection type sensor. An acceleration sensor I/F 84 converts analog output signals from the respective sensors into digital signals to output acceleration data a. The acceleration data a are data indicating resultant force of inertial force and gravity in the coordinate system fixed to the portable equipment 1, with which the three-dimensional acceleration sensor 80 is integrated such that the three-dimensional acceleration sensor 80 operates simultaneously with the portable equipment 1, the acceleration data being a vector having a vector having x axis, y axis, and z axis components.

When the portable equipment 1 is in a stationary state or in a uniform motion along a straight line, therefore, the acceleration data a become vector data indicating the magnitude and direction of the acceleration g of gravity in the coordinate system fixed to the portable equipment 1.

The three-dimensional angular velocity sensor 90 includes an X axis angular velocity sensor 91, a Y axis angular velocity sensor 92, and a Z axis angular velocity sensor 93. An angular velocity sensor I/F 94 converts analog output signals from the respective sensors into digital signals to output angular velocity data ω. The angular velocity data ω are vector data indicating angular velocities around the respective axes extending in three directions in the coordinate system fixed to the portable equipment 1.

The CPU 10 executes the attitude estimation program 100 stored in the ROM 30 to estimate the attitude q of the portable equipment 1. That is, since the CPU 10 executes the attitude estimation program 100, the portable equipment 1 functions as an attitude estimation apparatus.

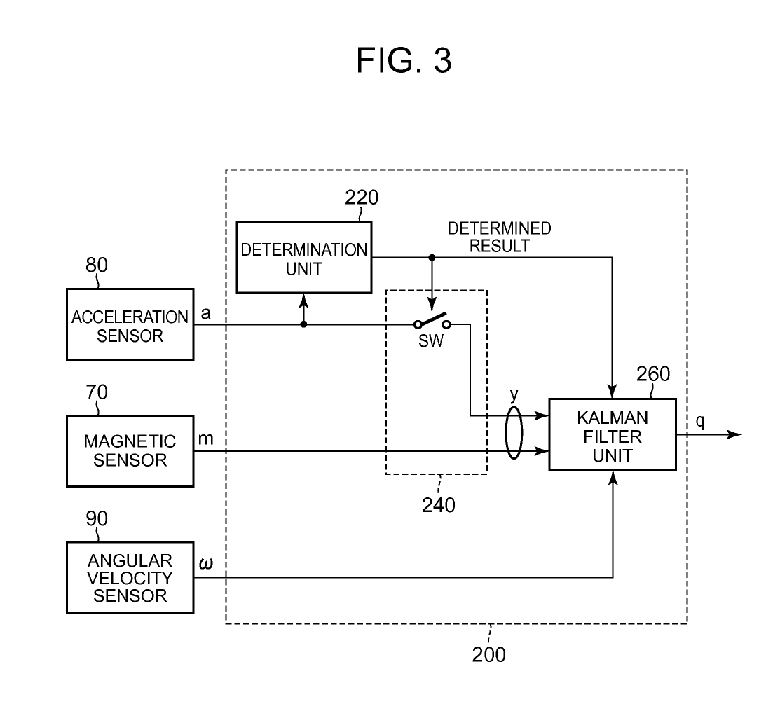

FIG. 3 is a function block diagram showing a function of the attitude estimation apparatus (i.e. a function realized by the CPU 10 executing the attitude estimation program 100). As shown in FIG. 3, the attitude estimation apparatus includes an attitude estimation unit 200 for estimating the attitude q of the portable equipment 1 based on the acceleration data a, the magnetic data m, and the angular velocity data ω. The attitude estimation unit 200 includes a determination unit 220, an observed value vector generation unit 240, and a Kalman filter unit 260.

The determination unit 220 determines whether motion of the portable equipment 1 is stable, i.e. whether great vibration is generated in the portable equipment 1, based on the acceleration data a.

Specifically, the determination unit 220 determines whether a condition represented by Equation (1) below, i.e. a condition of ‘an absolute value of a differential value between the magnitude of the vector represented by the acceleration data a and the magnitude g of the acceleration of gravity is less than a predetermined threshold value εG,’ is satisfied. Upon determining that the condition is satisfied, the determination unit 220 determines that motion of the portable equipment 1 is stable. Upon determining that the condition is not satisfied, the determination unit 220 determines that motion of the portable equipment 1 is unstable (the portable equipment 1 is vibrating).

Meanwhile, a subscript k attached to the right lower part of a variable, a vector, and a matrix, indicates a value of the variable, the vector, and the matrix at time T=k. Hereinafter, a three-dimensional vector indicating acceleration data a at time T=k will be referred to as an acceleration vector aₖ, a three-dimensional vector indicating magnetic data m at time T=k will be referred to as a magnetic vector mₖ, and a three-dimensional vector indicating angular velocity data ω at time T=k will be referred to as an angular velocity vector ωₖ.

|∥aₖ∥−g|<ε_{G} Equation (1)

The observed value vector generation unit 240 generates an observed value vector y having at least one of the respective components of the acceleration data a and the respective components of the magnetic data m as an element based on a determined result of the determination unit 220 and outputs the generated observed value vector to the Kalman filter unit 260. The observed value vector may be simply called “observation value” in some occasions.

Specifically, in a case in which the determined result of the determination unit 220 is positive (i.e. in a case in which it is determined that motion of the portable equipment 1 is stable), the observed value vector generation unit 240 generates an observed value vector yₖ, which is a six-dimensional vector having the acceleration vector aₖ and the magnetic vector mₖ as elements, as represented by Equation (2) below.

On the other hand, in a case in which the determined result of the determination unit 220 is negative (i.e. in a case in which it is determined that the portable equipment 1 is vibrating), the observed value vector generation unit 240 generates an observed value vector yₖ, which is a three-dimensional vector having the magnetic vector mₖ as an element, as represented by Equation (3) below.

$$\begin{matrix}{y}_{k} = [ \begin{matrix}{m}_{k} \\ {a}_{k}\end{matrix} ] & Equation ( 2 ) \\ {y}_{k} = [ {m}_{k} ] & Equation ( 3 )\end{matrix}$$

In this embodiment, the observed value vector generation unit 240 includes a switch SW provided between the three-dimensional acceleration sensor 80 and the Kalman filter unit 260.

The switch SW is turned on in a case in which the determined result of the determination unit 220 is positive. In this case, the observed value vector generation unit 240 transmits both the acceleration vector a output by the three-dimensional acceleration sensor 80 and the magnetic vector m output by the three-dimensional magnetic sensor 70 to the Kalman filter unit 260.

On the other hand, the switch SW is turned off in a case in which the determined result of the determination unit 220 is negative. In this case, the observed value vector generation unit 240 transmits only the magnetic vector m output by the three-dimensional magnetic sensor 70 to the Kalman filter unit 260.

The Kalman filter unit 260 performs a Kalman filter calculation based on the angular velocity data co output by the three-dimensional angular velocity sensor 90 and the observed value vector y to estimate the attitude q of the portable equipment 1.

As described above, the observed value vector y is a six-dimensional vector in a case in which the determined result of the determination unit 220 is positive and a three-dimensional vector in a case in which the determined result of the determination unit 220 is negative. For this reason, the Kalman filter unit 260 according to this embodiment estimates the attitude q of the portable equipment 1 while considering dimension of the observed value vector y based on the determined result of the determination unit 220.

Hereinafter, operation of the Kalman filter unit 260 will be described in detail.

<2. Kalman Filter Calculation>

Generally, the Kalman filter predicts a state of a dynamic system (at time T=k) after the lapse of a predetermined period, i.e., unit time from the state of the system at a certain time (at time T=k−1) using a state transition model, which is a logical model, indicating time-based change or transition of the state of the system.

In addition, the Kalman filter estimates an observed value vector yₖ from a predicted value of the state of the system using an observation model, which is a logical model, indicating a relationship between the predicted value of the state of the system predicted using the state transition model and the observed value vector yₖ. Hereinafter, an estimated value of the observed value vector yₖ will be referred to as an estimated observed value vector y⁻ₖ.

Subsequently, the Kalman filter calculates an observation residual eₖ, which is a difference between the estimated observed value vector y⁻ₖ and the observed value vector yₖ, which is a real observed value.

In addition, the Kalman filter corrects (updates) the predicted value of the state of the system predicted using the state transition model based on the observation residual eₖ to calculate an estimated value of the state of the system after the lapse of unit time from a certain time.

In this embodiment, the attitude q of the portable equipment 1 is included in the state of the system estimated by the Kalman filter (the Kalman filter unit 260). That is, the Kalman filter unit 260 calculates (estimates) an estimated attitude q⁺ₖ, which is an estimated value of the attitude q of the portable equipment 1 at time T=k (second time), based on an estimated attitude q⁺ₖ₋₁, which is an estimated value of the attitude q of the portable equipment 1 at time T=k−1 (first time).

In this embodiment, the attitude q is expressed using a quaternion. The quaternion is a four-dimensional number indicating an attitude (rotational state) of an object. For example, an attitude when the respective axes of the coordinate system fixed to the portable equipment 1 coincide with the respective axes of the coordinate system fixed to the ground is defined as a reference attitude, and the reference attitude is expressed as q=[0, 0, 0, 1]^{T}. At this time, an arbitrary attitude q of the portable equipment 1 can be expressed as an attitude when the portable equipment 1 is rotated by an angle ψ using an axis extending in the direction of a three-dimensional unit vector ρ as a rotational axis with respect to the reference attitude. That is, the attitude q is represented by equation (4) below using the quaternion.

$$q = [ \begin{matrix}{q}_{1} \\ {q}_{2} \\ {q}_{3} \\ {q}_{4}\end{matrix} ] = [ \begin{matrix}ρ sin ( \frac{ψ}{2} ) \\ cos ( \frac{ψ}{2} )\end{matrix} ] \qquad Equation ( 4 )$$

In addition, in this embodiment, an estimated attitude error δq⁺ₖ, which is a value estimating a difference between an attitude predicted value q⁻ₖ, which is a predicted value of the attitude q after the lapse of unit time (at time T=k) obtained using the state transition model, and an actual attitude q after the lapse of unit time (hereinafter, also simply referred to as a difference from the actual attitude), is included in the state of the system estimated by the Kalman filter (the Kalman filter unit 260). In this embodiment, the estimated attitude error δq⁺ₖ is expressed using the quaternion.

In this embodiment, the state transition model of the Kalman filter is represented by Equation (5) below using a nonlinear function f. A state vector xₖ present in Equation (5) is a three-dimensional vector expressing the estimated attitude error δq⁺ₖ, which is a variation of the attitude, using modified Rodrigues parameters (MRPs). A state vector x⁻ₖ after update, which will hereinafter be described, coincides with the estimated attitude error δq⁺ₖ (Strictly speaking, only expression types differ). In addition, a process noise wₖ present in Equation (5) is a three-dimensional vector, which is a Gauss noise having 0 as the center. Meanwhile, a covariance matrix of the process noise wₖ is denoted by Qₖ. The covariance matrix Qₖ is a square matrix of 3×3.

As represented by Equation (5), the state transition model predicts a state vector xₖ at time T=k after the lapse of unit time based on an angular velocity vector ωₖ₋₁ at time T=k−1. Generally, time T=k−1 is referred to as “first time” and time T=k is referred to as “second time”. Hereinafter, the state vector xₖ predicted using the state transition model will be referred to as a predicted state vector x⁻ₖ.

xₖ=f(ωₖ₋₁)+wₖ₋₁ Equation (5)

Although the state transition model is expressed as a means for predicting the state vector xₖ, which is a variation of the attitude as represented by Equation (5), the state transition model may be more concretely expressed as a means for predicting time-based change of the attitude q as represented by Equation (6) below.

An operator Ω present at the right side of Equation (6) is defined by Equation (7). In addition, I_{3×3} of Equation (7) represents a unit matrix of 3×3. An operator Γ of Equation (7) is defined by Equation (8) using a three-dimensional vector l=(l₁, l₂, l₃). Δt is unit time (time from time T=k−1 to time T=k). A component Ψₖ of Equation (7) is defined by Equation (9).

As represented by Equation (6), the state transition model predicts an attitude qₖ at time T=k after the lapse of unit time based on the attitude qₖ₋₁ at time T=k−1 and the angular velocity vector ωₖ₋₁ at time T=k−1. As described above, the attitude qₖ predicted using the state transition model is the attitude predicted value qₖ.

$$\begin{matrix} {q}_{k} = Ω ( {ω}_{k - 1} ) {q}_{k - 1} & Equation ( 6 ) \\ Ω ( {ω}_{k} ) = ⌈ \begin{matrix}cos ( \frac{1}{2} ‖ {ω}_{k} ‖ Δ t ) {I}_{3 \times 3} - Γ [ {Ψ}_{k} ] & {Ψ}_{k} \\ - {Ψ}_{k}^{T} & cos ( \frac{1}{2} ‖ {ω}_{k} ‖ Δ t )\end{matrix} ⌉ & Equation ( 7 ) \\ Γ [ ι ] = [ \begin{matrix}0 & - {ι}_{3} & {ι}_{2} \\ {ι}_{3} & 0 & - {ι}_{1} \\ - {ι}_{2} & {ι}_{1} & 0\end{matrix} ] & Equation ( 8 ) \\ {Ψ}_{k} = sin ( \frac{1}{2} ‖ {ω}_{k} ‖ Δ t ) \frac{{ω}_{k}}{‖ {ω}_{k } ‖} & Equation ( 9 )\end{matrix}$$

In this embodiment, the observation model of the Kalman filter is represented by Equation (10) below using a nonlinear function h. An observed noise vₖ present in Equation (10) is a Gauss noise having 0 as the center. Meanwhile, a covariance matrix of the observed noise vₖ is denoted by Rₖ.

As described above, the observed value vector yₖ is a six-dimensional vector having the acceleration vector aₖ and the magnetic vector mₖ as elements in a case in which the determined result of the determination unit 220 is positive and a three-dimensional vector having the magnetic vector mₖ as an element in a case in which the determined result of the determination unit 220 is negative. In a case in which the determined result of the determination unit 220 is positive, therefore, the observed noise vₖ is a six-dimensional vector indicating noise of the three-dimensional magnetic sensor 70 and noise of the three-dimensional acceleration sensor 80 and the covariance matrix Rₖ is a square matrix of 6×6. In a case in which the determined result of the determination unit 220 is negative, on the other hand, the observed noise vₖ is a three-dimensional vector indicating noise of the three-dimensional magnetic sensor 70 and the covariance matrix Rₖ is a square matrix of 3×3.

As represented by Equation (10), the observation model estimates an observed value vector yₖ at time T=k using the attitude qₖ at time T=k. As described above, the observed value vector estimated using the observation model is referred to as the estimated observed value vector yₖ or simply ‘estimated observation value’.

Meanwhile, details of the nonlinear function h will hereinafter be described in detail.

yₖ=h(qₖ)+vₖ Equation (10)

The observation residual eₖ at time T=k is a vector indicating a difference between the real observed value vector yₖ as inputted and the estimated observed value vector y⁻ₖ and is represented by Equation (11) below. As can be seen from Equation (10) and Equation (11), the observation residual eₖ is a six-dimensional vector in a case in which the determined result of the determination unit 220 is positive and a three-dimensional vector in a case in which the determined result of the determination unit 220 is negative.

As represented by Equation (12) below, the Kalman filter updates the state vector xₖ from the predicted state vector x⁻ₖ to a state vector x⁺ₖ using the observation residual eₖ and a Kalman gain Kₖ represented by Equation (13). In addition, the Kalman filter updates a covariance matrix Pₖ of an estimated error of the state vector xₖ as represented by Equation (14) below. Here, P⁻ₖ is a covariance matrix of an estimated error of the predicted state vector x⁻ₖ and P⁺ₖ is a covariance matrix of an estimated error of the state vector x⁺ₖ after update. In addition, P^{yy}ₖ is a covariance matrix of the observation residual eₖ and P^{xy}ₖ is a mutual covariance matrix of the predicted state vector x⁻ₖ and the estimated observed value vector y⁻ₖ.

eₖ=yₖ−y⁻ₖ Equation (11)

x⁺ₖ=x⁻ₖ+Kₖeₖ Equation (12)

Kₖ=P^{xy}ₖ(P^{yy}ₖ)⁻¹ Equation (13)

P⁺ₖ=P⁻ₖ−KₖP^{yy}ₖK^{T}ₖ Equation (14)

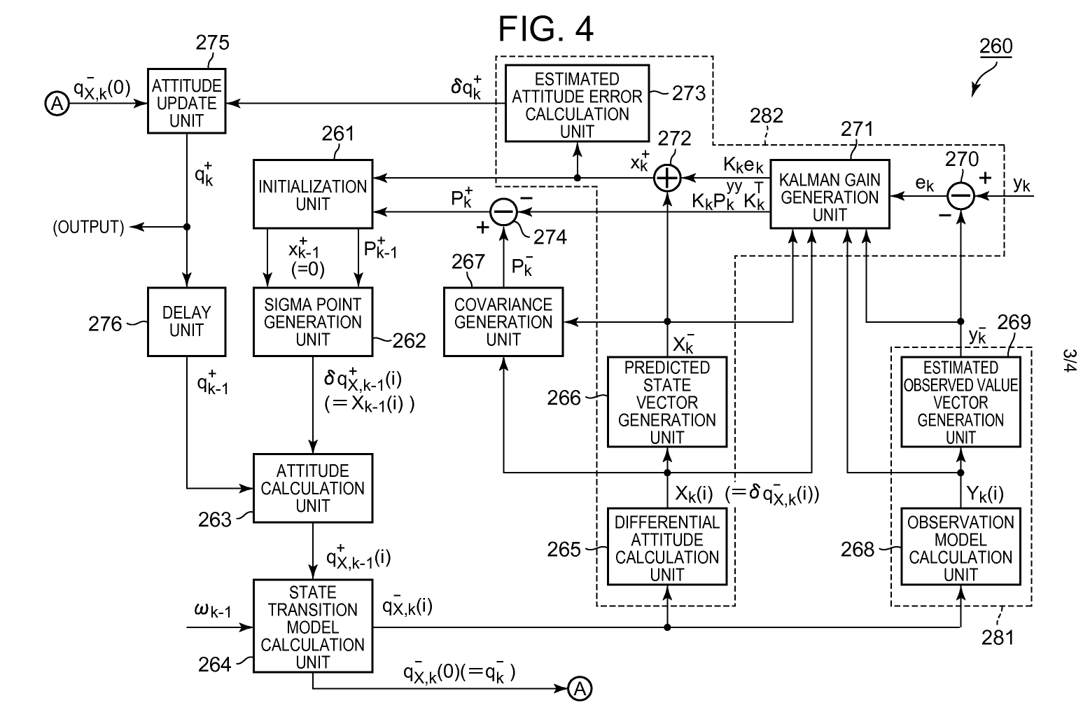

A function block diagram of the Kalman filter unit 260 is shown in FIG. 4. The Kalman filter unit 260 performs the nonlinear Kalman filter calculation represented by Equation (6) to Equation (14) through a sigma point Kalman filter using unscented transformation.

As shown in FIG. 4, an initialization unit 261 sets each element of a state vector x⁺ₖ₋₁ to 0 and then outputs it, the state vector x⁺ₖ₋₁ being obtained by delaying a state vector x⁺ₖ after update outputted by an adder 272 by unit time. That is, the initialization unit 261 substantially generates and outputs a zero vector O₃=[0, 0, 0]^{T}.

In addition, the initialization unit 261 delays the covariance matrix P⁺ₖ of the estimated error of the state vector x⁺ₖ after update by unit time to generate and output a covariance matrix P⁺ₖ₋₁ of an estimated error of a state vector x⁺ₖ₋₁.

A sigma point generation unit 262 generates 2dim(x)+1 sigma points xₖ₋₁(i) (where i=1, 2, 3, . . . , 2dim(x)) based on the covariance matrix P⁺ₖ₋₁ and the zero vector O₃ (i.e. the state vector x⁺ₖ₋₁, each element of which is set to 0). Here, each of the sigma points χₖ₋₁(i) is a three-dimensional vector and a sigma point χₖ₋₁(0) is a state vector x⁺ₖ₋₁, each element of which is set to 0 (i.e. a zero vector O₃). In addition, dim(x) is an integer indicating dimension of the state vector xₖ, i.e. 3. That is, the sigma point generation unit 262 generates seven (7) sigma points. The sigma points may be generated properly using a well known method, such as the method disclosed in non-patent literature 1.

In addition, the sigma point generation unit 262 converts the expression type of each of the 2dim(x)+1 sigma points χₖ₋₁(i), which are three-dimensional vectors, into a quaternion to convert the 2dim(x)+1 sigma points χₖ₋₁(i) into 2dim(x)+1 sigma points δq⁺_{χ,k-1}(i). The operation of converting the sigma points χₖ₋₁(i) into the sigma points δq⁺_{χ,k-1}(i), i.e. the operation of converting an expression type of the attitude from the MRPs to the quaternion, may be performed properly using a well known method, such as the method disclosed in non-patent literature 1.

A sigma point δq⁺_{χ,k-1}(0) converted from the sigma points χₖ₋₁(0) represents a reference attitude [0, 0, 0, 1]^{T}. In addition, each of the sigma points δq⁺_{χ,k-1}(i) represents a variation of the attitude from the reference attitude.

A delay unit 276 outputs an estimated attitude q⁺ₖ₋₁ obtained by delaying the estimated attitude q⁺ₖ at time T=k output by an attitude update unit 275 by unit time. A value of estimated attitude q⁺ₖ₋₁ at time T=k−1 delayed by the delay unit 276 is referred as ‘first estimation value’.

An attitude calculation unit 263 generates 2dim(x)+1 attitudes q⁺_{χ,k-1}(i) corresponding to the 2dim(x)+1 sigma points δq⁺_{χ,k-1}(i) based on the estimated attitude q⁺ₖ₋₁ and the sigma points δq⁺_{χ,k-1}(i) as represented by Equation (15) below.

Here, an operator [X] present in Equation (15) means a quaternion product. As can also be seen from Equation (4), the quaternion indicates a variation (magnitude of rotation about an arbitrary axis) of an attitude in addition to the attitude. In addition, the quaternion product is a well known operation of considering one quaternion as an attitude and the other quaternion as a variation of the attitude to change the attitude represented by the one quaternion by the variation of the attitude represented by the other quaternion.

As described above, the sigma points δq⁺_{χ,k-1}(i) represent variations of attitudes from the reference attitude. Consequently, the attitudes q⁺_{χ,k-1}(i) of Equation (15) are obtained by changing the estimated attitude q⁺ₖ₋₁ by the variation of the attitude represented by the sigma points δq⁺_{χ,k-1}(i).

The sigma point δq⁺_{χ,k-1}(0) indicating the reference attitude represents that the attitude is not changed (the variation of the attitude is zero). As represented by Equation (16), therefore, an attitude q⁺_{χ,k-1}(0) obtained by changing the estimated attitude q⁺ₖ₋₁ through the sigma point δq⁺_{χ,k-1}(0) is equal to the estimated attitude q⁺ₖ₋₁.

q⁺_{χ,k-1}(i)=δq⁺_{χ,k-1}(i)[×]q⁺ₖ₋₁ (i=0, . . . , 2dim(x)) Equation (15)

q⁺_{χ,k-1}(0)=q⁺ₖ₋₁ Equation (16)

A state transition model calculation unit 264 (hereinafter, also simply referred to as a ‘state transition model unit’) applies the 2dim(x)+1 attitudes q⁺_{χ,k-1}(i) generated by the attitude calculation unit 263 and the angular velocity vector ωₖ₋₁ to the state transition model represented by Equation (6) to generate 2dim(x)+1 attitude predicted values q⁻_{χ,k}(i).

Meanwhile, an attitude predicted value q⁻_{χ,k}(0) obtained by applying the attitude q⁺_{χ,k-1}(0) to Equation (6) is equal to an attitude predicted value q⁻ₖ obtained by applying the estimated attitude q⁺ₖ₋₁ output by the delay unit 276 to Equation (6).

A differential attitude calculation unit 265 calculates a variation of the attitude when the attitude is changed from the attitude represented by the attitude predicted value q⁻_{χ,k}(0) to the attitudes represented by the attitude predicted values q⁻_{χ,k}(i) based on the attitude predicted values q_{χ,k}(i) generated by the state transition model calculation unit 264 and the attitude predicted value q⁻_{χ,k}(0). The variation of the attitude may be calculated properly using a well known method, such as the method disclosed in non-patent literature 1. Consequently, the differential attitude calculation unit 265 converts the 2dim(x)+1 attitude predicted values q⁻_{χ,k}(i) into 2dim(x)+1 sigma points δq⁻_{χ,k}(i), which are variations of the attitude from the attitude predicted value q⁻_{χ,k}(0).

In addition, the differential attitude calculation unit 265 converts the expression type of each of the 2dim(x)+1 sigma points δq⁻_{χ,k}(i) expressed in the quaternion into MRPs to generate 2dim(x)+1 sigma points χₖ(i). The conversion of the expression type of the attitude from the quaternion into the MRPs may be performed properly using a well known method, such as the method disclosed in non-patent literature 1.

A predicted state vector generation unit 266 generates a predicted state vector x⁻ₖ, which is a weighted average of the 2dim(x)+1 sigma points χₖ(i) generated by the differential attitude calculation unit 265. The weighted average may be calculated properly using a well known method.

A covariance generation unit 267 generates a covariance matrix P⁻ₖ of an estimated error of the predicted state vector x⁻ₖ based on the predicted state vector x⁻ₖ and the sigma points χₖ(i). This calculation may be performed properly using a well known method.

An observation model calculation unit 268 applies the 2dim(x)+1 attitude predicted values q⁻_{χ,k}(i) generated by the state transition model calculation unit 264 to an observation model to generate 2dim(x)+1 estimated observed values γₖ(i) as represented by Equation (17) below.

γₖ(i)=h(q⁻_{χ,k}(i))(i=0, . . . , 2dim(x)) Equation (17)

Hereinafter, the nonlinear function h used in the observation model will be described in detail.

In a case in which the determined result of the determination unit 220 is positive, the nonlinear function h is represented by Equation (18) below. On the other hand, in a case in which the determined result of the determination unit 220 is negative, the nonlinear function h is represented by Equation (19) below.

Here, γₘ is an estimated value of the magnetic vector mₖ, which is represented by Equation (20) below. A vector ^{G}B_{g} present in Equation (20) is a vector indicating a direction and magnitude of the geomagnetism B_{g} in the coordinate system fixed to the ground, which is represented by Equation (21) below. A value r present in Equation (21) is a value indicating intensity of the geomagnetism B_{g} and a value Φ present in Equation (21) is a value indicating a magnetic dip of the geomagnetism B_{g}. In addition, a matrix B(q) present in Equation (20) is a matrix performing coordinate conversion from a vector expressed in the coordinate system fixed to the ground to a vector expressed in the coordinate system fixed to the portable equipment 1 in a case in which the portable equipment 1 is in the attitude q, which is represented by Equation (22) below.

γₐ is an estimated value of the acceleration vector aₖ, which is represented by Equation (23) below. A vector ^{G}G_{RV} present in Equation (23) is three-dimensional vector obtained by normalizing a vector indicating a direction and magnitude of acceleration of gravity to a magnitude g of acceleration of gravity in the coordinate system fixed to the ground.

$$\begin{matrix} h ( {q}_{k} ) = [ \begin{matrix}{γ}_{m} \\ {γ}_{a}\end{matrix} ] & Equation ( 18 ) \\ h ( {q}_{k} ) = [ {γ}_{m} ] & Equation ( 19 ) \\ {γ}_{m} = {B ( {q}_{k} )}^{G} {B}_{g} & Equation ( 20 ) \\ {}_{}^{ G}{B}{}_{g}^{} = ⌈ \begin{matrix}\begin{matrix}0 \\ r cos Φ\end{matrix} \\ - r sin Φ\end{matrix} ⌉ & Equation ( 21 ) \\ B ( q ) = [ \begin{matrix}\begin{matrix}{q}_{4}^{2} + {q}_{1}^{2} - \\ {q}_{2}^{2} - {q}_{3}^{2}\end{matrix} & 2 ( {q}_{1} {q}_{2} + {q}_{4} {q}_{3} ) & 2 ( {q}_{1} {q}_{3} - {q}_{4} {q}_{2} ) \\ 2 ( {q}_{2} {q}_{1} - {q}_{4} {q}_{3} ) & \begin{matrix}{q}_{4}^{2} - {q}_{1}^{2} + \\ {q}_{2}^{2} - {q}_{3}^{2}\end{matrix} & 2 ( {q}_{2} {q}_{3} + {q}_{4} {q}_{1} ) \\ 2 ( {q}_{3} {q}_{1} + {q}_{4} {q}_{2} ) & 2 ( {q}_{3} {q}_{2} - {q}_{4} {q}_{1} ) & \begin{matrix}{q}_{4}^{2} - {q}_{1}^{2} - \\ {q}_{2}^{2} + {q}_{3}^{2}\end{matrix}\end{matrix} ] & Equation ( 22 ) \\ {γ}_{a} = {B ( {q}_{k} )}^{G} {G}_{RV} & Equation ( 23 ) \\ { }^{G} {G}_{RV} = {[ \begin{matrix}0 & 0 & - 1\end{matrix} ]}^{T} & Equation ( 24 )\end{matrix}$$

An estimated observed value vector generation unit 269 generates an estimated observed value vector y⁻ₖ, which is a weighted average of the 2dim(x)+1 estimated observed values γₖ(i) generated by the observation model calculation unit 268. Meanwhile, the weighted average may be calculated properly using a well known method.

The observation model calculation unit 268 and the estimated observed value vector generation unit 269 function as an observation model unit 281 for applying the attitude predicted values q⁻_{χ,k}(i) to an observation model to generate an estimated observed value vector y⁻ₖ (estimated observation value).

A subtractor 270 subtracts the estimated observed value vector y⁻ₖ from the observed value vector yₖ (input observation value) to generate an observation residual eₖ.

A Kalman gain generation unit 271 generates a covariance matrix P^{yy}ₖ of the observation residual eₖ based on the estimated observed value vector y⁻ₖ, the 2dim(x)+1 estimated observed values γₖ(i), and the covariance matrix Rₖ of the observed noise vₖ. In addition, the Kalman gain generation unit 271 generates a mutual covariance matrix P^{xy}ₖ of the predicted state vector x⁻ₖ and the estimated observed value vector y⁻ₖ based on the predicted state vector x⁻ₖ, the estimated observed value vector y⁻ₖ, the 2dim(x)+1 sigma points χₖ(i), and the 2dim(x)+1 estimated observed values γₖ(i). Meanwhile, the covariance matrix P^{yy}ₖ and the mutual covariance matrix P^{xy}ₖ may be generated by the Kalman gain generation unit 271 properly using a well known method, such as the method disclosed in non-patent literature 1.

Next, the Kalman gain generation unit 271 generates a Kalman gain Kₖ based on the covariance matrix P^{yy}ₖ and the mutual covariance matrix P^{xy}ₖ as represented by Equation (13). The Kalman gain Kₖ is a matrix of 3×6 in a case in which the determined result of the determination unit 220 is positive and a matrix of 3×3 in a case in which the determined result of the determination unit 220 is negative.

In addition, the Kalman gain generation unit 271 generates a three-dimensional vector Kₖeₖ present at the second term of the right side of Equation (12) based on the Kalman gain Kₖ and the observation residual eₖ to generate a matrix of 3×3 KₖP^{yy}ₖKₖ^{T} present at the second term of the right side of Equation (14) based on the Kalman gain Kₖ and the covariance matrix P^{yy}ₖ.

An adder 272 adds the vector Kₖeₖ calculated by the Kalman gain generation unit 271 to the predicted state vector x⁻ₖ to generate a state vector x⁺ₖ after update as represented by Equation (12).

An estimated attitude error calculation unit 273 converts the expression type of the state vector x⁺ₖ after update expressed using MRPs into a quaternion to generate an estimated attitude error δq⁺ₖ.

Consequently, the differential attitude calculation unit 265, the predicted state vector generation unit 266, the subtractor 270, the Kalman gain generation unit 271, the adder 272, and the estimated attitude error calculation unit 273 function as an error estimation unit 282 for generating the observation residual eₖ based on the observed value vector yₖ and generating the estimated attitude error δq⁺ₖ based on the observation residual eₖ and the attitude predicted values q^{-χ,k}(i).

Meanwhile, in the following description, the observation model unit 281 and the error estimation unit 282 may be generically referred to as a ‘predicted value correction unit.’

A subtractor 274 subtracts the matrix KₖP^{yy}ₖKₖ^{T} calculated by the Kalman gain generation unit 271 from the covariance matrix P⁻ₖ of the estimated error of the predicted state vector x⁻ₖ to generate a covariance matrix P⁺ₖ of the estimated error of the state vector x⁺ₖ after update as represented by Equation (14).

An attitude update unit 275 generates an estimated attitude q⁺ₖ based on the attitude predicted value q⁻_{χ,k}(0) generated by the state transition model calculation unit 264 and the estimated attitude error δq⁺ₖ. A value of the estimated attitude q⁺ₖ at T=k is referred to as ‘second estimation value’. The estimated attitude q⁺ₖ generated by the attitude update unit 275 is output as an estimated value of the attitude q of the portable equipment 1.

Processes of generating the estimated attitude q⁺ₖ differ depending upon the determined result of the determination unit 220. Hereinafter, the processes of generating the estimated attitude q⁺ₖ in a case in which the determined result of the determination unit 220 is positive and negative will be separately described.

First, in a case in which the determined result of the determination unit 220 is positive, the attitude update unit 275 calculates an estimated attitude q⁺ₖ through a quaternion product of the estimated attitude error δq⁺ₖ and the attitude predicted value q⁻_{χ,k}(0) as represented by Equation (25) below.

q⁺ₖ=δq⁺ₖ[×]q⁻_{χ,k}(0) Equation (25)

As described above, the estimated attitude error δq⁺ₖ is a value obtained by estimating a difference between the attitude predicted value q⁻_{χ,k}(0) and the actual attitude q using an output value from the three-dimensional magnetic sensor 70 and an output value from the three-dimensional acceleration sensor 80. In addition, the attitude predicted value q⁻_{χ,k}(0) is a predicted value of the attitude q obtained based on an output value from the three-dimensional angular velocity sensor 90 using the state transition model. That is, the Kalman filter unit 260 estimates an estimated attitude q⁺ₖ using output values from the three-dimensional magnetic sensor 70, the three-dimensional acceleration sensor 80, and the three-dimensional angular velocity sensor 90.

Since the Kalman filter unit 260 integrates the output values from the three sensors to estimate the attitude in a case in which the determined result of the determination unit 220 is positive as described above, it is possible to correctly estimate the attitude.

On the other hand, in a case in which the determined result of the determination unit 220 is negative, the attitude update unit 275 calculates an estimated attitude q⁺ₖ as follows. Meanwhile, as described above, a quaternion may indicate not only an attitude but also a variation of the attitude. Quaternions q_{A} to q_{C} used in the following calculation involve two meanings as described above.

First, the attitude update unit 275 generates a quaternion q_{A} according to Equation (26) below. The quaternion q_{A} is a quaternion indicating an attitude obtained by changing the attitude predicted value q⁻_{χ,k}(0) by the estimated attitude error δq⁺ₖ.

Second, the attitude update unit 275 generates a quaternion q_{B} according to Equation (27) below. [q⁻_{χ,k}(0)]⁻¹ present in Equation (27) is an inverse quaternion of the attitude predicted value q⁻_{χ,k}(0).

The inverse quaternion is a four-dimensional number indicating an attitude change inverse to an attitude change indicated by the quaternion. Specifically, for example, in a case in which a quaternion qₒ indicates an attitude change from an attitude q₁ to an attitude q₂, an inverse quaternion [qₒ]⁻¹ indicates an attitude change from the attitude q₂ to the attitude q₁.

That is, the quaternion q_{B} indicates an attitude obtained by changing the attitude indicated as the quaternion q_{A} in a direction inverse to the attitude change indicated by the attitude predicted value q⁻_{χ,k}(0). In other words, the quaternion q_{A} indicates an attitude obtained by changing the attitude indicated by the attitude predicted value q⁻_{χ,k}(0) by the estimated attitude error δq⁺ₖ, whereas the quaternion q_{B} indicates an attitude obtained by changing the reference attitude=[0, 0, 0, 1]^{T} by the estimated attitude error δq⁺ₖ (i.e. just the estimated attitude error δq⁺ₖ).

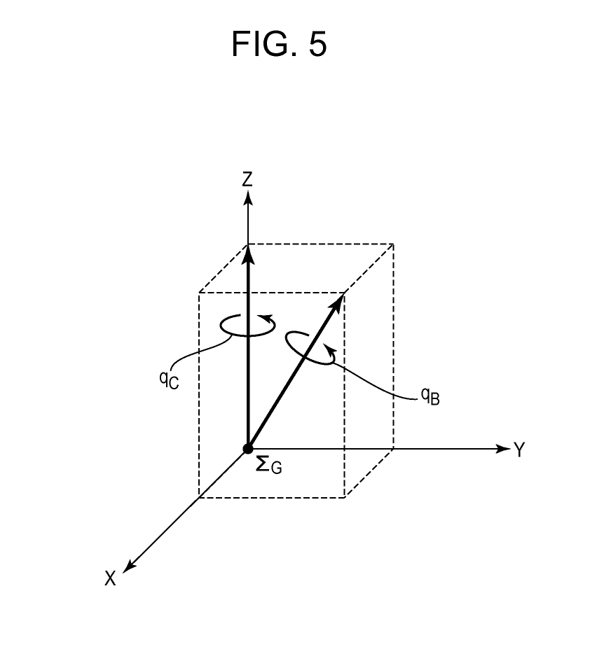

Third, the attitude update unit 275 generates a quaternion q_{c} (hereinafter, also referred to as an ‘extracted estimate attitude error’). As shown in FIG. 5, the quaternion q_{c} is a quaternion obtained by removing a component indicating an inclination or tilt from a Z axis (i.e. an axis extending in a direction of acceleration of gravity) of a coordinate system Σ_{G} fixed to the ground from the attitude change indicated by the quaternion q_{B} and extracting a rotation component having the Z axis as a rotational axis. The rotation component is a specific attitude component which is reliable and not affected by an unstable state of equipment as compared to the tilt component of the estimated attitude error.

More specifically, when each component of the quaternion q_{B} is represented by Equation (28) below, in a case in which a component q_{B4} of the quaternion q_{B} is equal to or greater than 0, the quaternion q_{c} is calculated according to Equation (29). On the other hand, in a case in which the component q_{B4} of the quaternion q_{B} is less than 0, the quaternion q_{c} is calculated according to Equation (30).

Fourth, the attitude update unit 275 calculates an estimated attitude q⁺ₖ through a quaternion product of the attitude predicted value q⁻_{χ,k}(0) and the quaternion q_{c} according to Equation (31).

$$\begin{matrix}{q}_{A} = δ {q}_{k}^{+} [ \times ] {q}_{χ , k}^{-} ( 0 ) & Equation ( 26 ) \\ {q}_{B} = {[ {q}_{χ , k}^{-} ( 0 ) ]}^{- 1} [ \times ] {q}_{A} & Equation ( 27 ) \\ {q}_{B} = [ \begin{matrix}{q}_{B 1} \\ {q}_{B 2} \\ {q}_{B 3} \\ {q}_{B 4}\end{matrix} ] & Equation ( 28 ) \\ {q}_{C} = [ \begin{matrix}0 \\ 0 \\ {q}_{B 3} \\ \sqrt{1 - {q}_{B 3}^{2}}\end{matrix} ] ( where {q}_{B 4} \geq 0 ) & Equation ( 29 ) \\ {q}_{C} = [ \begin{matrix}0 \\ 0 \\ {q}_{B 3} \\ - \sqrt{1 - {q}_{B 3}^{2}}\end{matrix} ] ( where {q}_{B 4} < 0 ) & Equation ( 30 ) \\ {q}_{k}^{+} = {q}_{χ , k}^{-} ( 0 ) [ \times ] {q}_{C} & Equation ( 31 )\end{matrix}$$

In a case in which the determined result of the determination unit 220 is negative, the acceleration vector aₖ is not included in the observed value vector y but only the magnetic vector mₖ is included in the observed value vector y. That is, in a case in which the determined result of the determination unit 220 is negative, in the observation model, the estimated value γₐ of the acceleration vector aₖ is not calculated but only the estimated value γₘ of the magnetic vector mₖ is estimated.

The estimated value γₐ of the acceleration vector aₖ represented by Equation (23) is an estimated value of a vector ^{S}G_{RV} obtained by expressing the vector ^{G}G_{RV} indicating a direction of acceleration of gravity in the coordinate system fixed to the ground as a vector in the coordinate system fixed to the portable equipment 1.

In a case in which it is possible to consider that the acceleration vector aₖ and the vector ^{S}G_{RV} coincide with each other, it is possible to know the direction of acceleration of gravity through the acceleration vector aₖ. In this case, therefore, it is possible to update the component indicating the inclination or tilt from the direction of acceleration of gravity in the estimated value of the attitude q of the portable equipment 1 estimated by the Kalman filter unit 260 such that the inclination is approximate to a real inclination based on the observation residual eₖ (more specifically, a component indicating a difference between the estimated value γₐ of the acceleration vector aₖ and the acceleration vector aₖ). That is, in a case in which the determined result of the determination unit 220 is positive and it is possible to assume that the acceleration vector aₖ and the vector ^{S}G_{RV} coincide with each other, the acceleration vector aₖ greatly contributes to estimation of a component indicating an inclination from a direction of acceleration of gravity in the attitude q of the portable equipment 1.

However, in a case in which the determined result of the determination unit 220 is negative, the acceleration vector aₖ and the vector ^{S}G_{RV} may be greatly different from each other. In this case, it is not possible to know a direction of acceleration of gravity based on the acceleration vector aₖ. In this case, therefore, a component indicating an inclination from the direction of acceleration of gravity in the estimated value of the attitude q of the portable equipment 1 estimated by the Kalman filter unit 260 may be updated to indicate an inclination greatly different from a real inclination.

However, the Kalman filter unit 260 according to this embodiment estimates an attitude q of the portable equipment 1 without calculating the acceleration vector aₖ in a case in which the determined result of the determination unit 220 is negative. Even in a case in which the acceleration vector aₖ and the vector ^{S}G_{RV} are greatly different from each other, therefore, it is possible to prevent a component indicating an inclination from the direction of acceleration of gravity in the estimated value of the attitude q of the portable equipment 1 from being updated to indicate an inclination greatly different from a real inclination.

On the other hand, the estimated value γₘ of the magnetic vector mₖ represented by Equation (23) is an estimated value of a vector ^{S}B_{g}(q) obtained by expressing the vector ^{G}B_{g} indicating the direction and magnitude of the geomagnetism B_{g} in the coordinate system fixed to the ground as a vector in the coordinate system fixed to the portable equipment 1. In addition, in this embodiment, the vector ^{G}B_{g} indicating the direction and magnitude of the geomagnetism B_{g} may be expressed using the magnetic dip Φ of the geomagnetism B_{g} as a parameter as represented by Equation (21). In a case in which it is possible to assume that the magnetic vector mₖ and the vector ^{S}B_{g}(q) coincide with each other, therefore, the magnetic vector mₖ becomes a value having the magnetic dip Φ of the geomagnetism B_{g} correctly reflected therein.

In addition, as described above, the perpendicular component (the component in the direction of acceleration of gravity) of the geomagnetism B_{g} is decided by the magnetic dip Φ. In a case in which the magnetic vector mₖ is a value having the magnetic dip Φ of the geomagnetism B_{g} correctly reflected therein, therefore, the direction of the perpendicular component of the geomagnetism B_{g} obtained from the magnetic vector mₖ and the direction of acceleration of gravity coincide with each other. That is, in a case in which it is possible to correctly know the magnetic dip Φ, it is possible to know the direction of acceleration of gravity from the direction of the geomagnetism B_{g}. In this case, it is possible to update the component indicating the inclination from the direction of acceleration of gravity in the estimated value of the attitude q of the portable equipment 1 such that the inclination is approximate to a real inclination based on the magnetic vector mₖ and the estimated value γₘ of the magnetic vector mₖ.

However, in a case in which an object generating a magnetic field is present in the vicinity of the portable equipment 1 and the magnetic field generated by the object is superimposed on the value indicating the magnetic data m (the magnetic vector mₖ) as noise, the magnetic vector mₖ and vector ^{S}B_{g}(q) may greatly deviate from each other. In this case, the magnetic vector mₖ does not become a value having the magnetic dip Φ of the geomagnetism B_{g} correctly reflected therein and the direction of the perpendicular component of the geomagnetism B_{g} obtained from the magnetic vector mₖ and the direction of acceleration of gravity greatly deviate from each other. In this case, therefore, the component indicating the inclination from the direction of acceleration of gravity in the estimated value of the attitude q of the portable equipment 1 is updated to indicate an inclination different from a real inclination. That is, the component indicating the inclination from the direction of acceleration of gravity in the estimated value of the attitude q may not be correctly estimated even though the attitude q of the portable equipment 1 is estimated based on only the magnetic vector mₖ.

However, the attitude update unit 275 according to this embodiment calculates an estimated attitude q⁺ₖ using a quaternion q_{c} obtained by removing a component indicating an inclination from an axis extending in the direction of acceleration of gravity from the estimated attitude error δq⁺ₖ generated based on the magnetic vector mₖ and the estimated value γₘ of the magnetic vector mₖ and extracting a rotation component having the axis as a rotational axis in a case in which the determined result of the determination unit 220 is negative. In a case in which the determined result of the determination unit 220 is negative, therefore, the attitude update unit 275 is prevented from estimating the component indicating the inclination from the direction of acceleration of gravity in the attitude q of the portable equipment 1 based on the magnetic vector mₖ.

Even in a case in which the magnetic vector mₖ and vector ^{S}B_{g}(q) are greatly different from each other and the magnetic vector mₖ is not a value having the magnetic dip 0 of the geomagnetism B_{g} correctly reflected therein, therefore, it is possible to prevent a component indicating an inclination from the direction of acceleration of gravity in the estimated value of the attitude q of the portable equipment 1 from being updated to indicate an inclination greatly different from a real inclination.

Consequently, it is possible for the attitude estimation apparatus according to this embodiment to prevent estimation of an attitude greatly deviating from an actual attitude even in a case in which a noise component other than components to be detected by the sensors is detected.

### B. Modifications

The present invention is not limited to the above embodiment but may be modified as follows. In addition, two or more of the following modifications can be combined.

(1) First Modification

Although the portable equipment 1 according to the above embodiment performs the nonlinear Kalman filter calculation using the sigma point Kalman filter, the present invention is not limited thereto. The nonlinear Kalman filter calculation may be performed properly using a well-known nonlinear Kalman filter, such as an extended Kalman filter.

(2) Second Modification

Although, in the embodiment and the modification as described above, the attitude estimation unit 200 includes the observed value vector generation unit 240, the observed value vector generation unit 240 may not be provided. That is, the observed value vector yₖ may have the acceleration vector aₖ and the magnetic vector mₖ as elements on a constant basis.

The Kalman filter unit 260 according to the present invention calculates an estimated attitude q⁺ₖ based on the determined result of the determination unit 220. That is, in a case in which the determined result of the determination unit 220 is negative, the Kalman filter unit 260 calculates an estimated attitude q⁺ₖ using a quaternion q_{c} obtained by extracting a rotation component having an axis extending in the direction of acceleration of gravity in the estimated attitude error δq⁺ₖ as a rotational axis. Even in a case in which the determined result of the determination unit 220 is negative and the acceleration vector aₖ and the vector ^{S}G_{RV} may be greatly different from each other, therefore, it is possible to prevent a component indicating an inclination from the direction of acceleration of gravity in the estimated value of the attitude q of the portable equipment 1 from being updated to indicate an inclination greatly different from a real inclination.

(3) Third Modification

Although, in the embodiment and the modifications as described above, the portable equipment 1 includes the three-dimensional magnetic sensor 70, the three-dimensional acceleration sensor 80, and the three-dimensional angular velocity sensor 90, the present invention is not limited thereto. Sensors other than these three kinds of sensors may be provided. In addition, a plurality of sensors including at least the three-dimensional acceleration sensor 80 of these three kinds of sensors may be provided.

That is, the attitude estimation apparatus according to the present invention may be provided in portable equipment 1 including a plurality of sensors for measuring different kinds of physical quantities such that the attitude estimation apparatus performs a Kalman filter calculation to integrate outputs from these sensors and to estimate a state of the system.

In a case in which motion of the equipment, in which the attitude estimation apparatus is provided, is not stable, noise caused due to vibration of the equipment may be superimposed on an output value from the three-dimensional acceleration sensor with the result that a vector indicating an output value from the three-dimensional acceleration sensor and a vector indicating acceleration of gravity may greatly deviate from each other. In this case, if an attitude of the equipment is estimated based on the output value from the three-dimensional acceleration sensor, a component indicating an inclination from a direction of acceleration of gravity in the estimated attitude may greatly deviate from an inclination of an actual attitude.

According to the present invention, in a case in which it is determined that motion of the equipment, in which the attitude estimation apparatus is provided, is not stable, the attitude update unit corrects a predicted result of the state transition model unit based on an extracted estimated attitude error obtained by extracting a rotation component having an axis extending in a direction of acceleration of gravity as a rotational axis from an estimated attitude error generated based on a observed value vector to calculate an estimated value of the attitude after the lapse of unit time. That is, the attitude update unit removes a component indicating an inclination or tilt to the direction of acceleration of gravity from the estimated attitude error in a case in which motion of the equipment, in which the attitude estimation apparatus is provided, is not stable. Even in a case in which the observed value vector has an output value from the three-dimensional acceleration sensor as an element and a vector indicating the output value from the three-dimensional acceleration sensor has a direction different from that of acceleration of gravity, therefore, it is possible to prevent estimation of an inclination of the attitude of the equipment from the direction of acceleration of gravity while assuming that the direction of the vector indicating the output value from the three-dimensional acceleration sensor and the direction of acceleration of gravity coincide with each other.

Consequently, it is possible for the attitude estimation apparatus according to the present invention to estimate a correct attitude of the equipment without updating a component indicating an inclination from a direction of acceleration of gravity in an estimated value of the attitude of the equipment, thereby preventing indication of an inclination greatly deviating from a real inclination.

In a case in which it is determined that motion of the equipment, in which the attitude estimation apparatus is provided, is not stable, the attitude estimation apparatus according to the present invention generates an observed value vector which does not include the output value from the three-dimensional acceleration sensor. In a case in which noise is superimposed on the output value from the three-dimensional acceleration sensor, therefore, it is possible for the attitude estimation apparatus to prevent estimation of an attitude of the equipment based on the output value from the three-dimensional acceleration sensor.

Generally, a direction of geomagnetism is expressed using a magnetic dip of the geomagnetism as a parameter. In a case in which it is possible to assume that a vector indicating an output value from the three-dimensional magnetic sensor and a vector indicating the geomagnetism coincide with each other, therefore, the output value from the three-dimensional magnetic sensor becomes a value having the magnetic dip of the geomagnetism correctly reflected therein. In addition, in this case, it is possible to assume that a direction of a gravity acceleration component of the geomagnetism obtained from the output value from the three-dimensional magnetic sensor and a real direction of acceleration of gravity coincide with each other. In this case, therefore, it is possible to correctly estimate an inclination of the attitude of the equipment from the direction of acceleration of gravity while referring to the direction of acceleration of gravity correctly obtained based on the output value from the three-dimensional magnetic sensor.

In a case in which an object generating a magnetic field is present in the vicinity of the equipment, however, noise caused due to the magnetic field generated by the object is superimposed on the output value from the three-dimensional magnetic sensor. In this case, the output value from the three-dimensional magnetic sensor does not become a value having the magnetic dip of the geomagnetism correctly reflected therein and a direction of the gravity acceleration component of the geomagnetism obtained from the output value from the three-dimensional magnetic sensor and a real direction of acceleration of gravity deviate from each other. In this case, therefore, it is not possible to correctly estimate an inclination of the attitude of the equipment from the direction of acceleration of gravity based on the output value from the three-dimensional magnetic sensor.

According to the present invention, in a case in which it is determined that motion of the equipment, in which the attitude estimation apparatus is provided, is not stable and an observed value vector is generated based on only the output value from the three-dimensional magnetic sensor, the attitude update unit corrects a predicted result of the state transition model unit with an extracted estimated attitude error obtained by removing a component indicating an inclination to a direction of acceleration of gravity from an estimated attitude error generated based on the observed value vector (the output value from the three-dimensional magnetic sensor) to calculate an estimated value of the attitude after the lapse of unit time. Even in a case in which the direction of the gravity acceleration component of the geomagnetism obtained from the output value from the three-dimensional magnetic sensor and the real direction of acceleration of gravity are different from each other, therefore, it is possible to prevent estimation of the inclination of the attitude of the equipment from the direction of acceleration of gravity while assuming that the directions coincide with each other. Consequently, it is possible for the attitude estimation apparatus according to the present invention to estimate a correct attitude of the equipment without updating a component indicating an inclination from a direction of acceleration of gravity in an estimated value of the attitude of the equipment, thereby preventing the attitude estimation apparatus from indicating an inclination greatly deviating from a real inclination.

In addition, in the above embodiments, the determination unit may determine that the motion of the equipment is stable in a case in which an absolute value of a difference between a magnitude of a vector indicating the output values from the three-dimensional acceleration sensor and a magnitude of acceleration of gravity is equal to or less than a predetermined value.

In a case in which the motion of the equipment is not stable, acceleration added to the equipment is superimposed on the output value from the three-dimensional acceleration sensor, In this state, the determination unit compares a magnitude of the output value from the three-dimensional acceleration sensor with that of acceleration of gravity. Consequently, it is possible for the determination unit to determine whether or not motion of the equipment is stable.

What is claimed is:

1. A method of estimating attitude of equipment having a plurality of sensors including an acceleration sensor, the method comprising:
generating a first estimation value of the attitude of the equipment at a first time;
determining whether the attitude of the equipment is stable or not, based on acceleration data outputted from the acceleration sensor;
predicting the attitude of the equipment at a second time after a predetermined period from the first time to thereby generate a predicted value of the attitude, by applying the first estimation value to a state transition model indicating transition of the attitude of the equipment;
estimating a difference between the predicted value of the attitude and a true value of the attitude of the equipment based on data outputted from at least one sensor included in the plurality of the sensors to thereby generate an estimated attitude error between the predicted attitude and true attitude of the equipment;
calculating a second estimation value of the attitude of the equipment at the second time based on the predicted value of the attitude and the estimated attitude error when the attitude of the equipment is determined to be stable;
extracting a specific attitude component from a plurality of attitude components of the estimated attitude error when the attitude of the equipment is determined to be not stable; and
calculating a second estimation value of the attitude of the equipment at the second time based on the predicted value of the attitude and the specific attitude component extracted from the estimated attitude error when the attitude of the equipment is determined to be not stable.

2. The method according to claim 1, wherein the plurality of attitude components of the estimated attitude error comprise a tilt component representing a tilt from an axis extending in a direction of gravity acceleration and a rotation component around the axis, and the specific attitude component is the rotation component obtained by removing the tilt component from the estimated attitude error.

3. The method according to claim 1, wherein the plurality of attitude components are obtained by changing reference attitude of the equipment by the estimated attitude error.

4. The method according to claim 1, wherein the attitude of the equipment is represented by quaternion.

5. The method according to claim 1,
wherein the plurality of sensors further include a magnetic sensor and an angular velocity sensor,
wherein the method further comprises: generating an input observation value including, as its elements, magnetic data outputted from the magnetic sensor and acceleration data outputted from the acceleration sensor when the attitude of the equipment is determined to be stable; and generating an input observation value including, as its elements, magnetic data outputted from the magnetic sensor and precluding acceleration data outputted from the acceleration sensor when the attitude of the equipment is determined to be not stable,
wherein the attitude of the equipment at the second time is predicted by applying the first estimation value at the first time and angular velocity data outputted from the angular velocity sensor to the state transition model, and
wherein the estimated attitude error is generated by: applying the predicted value of the attitude at the second time to an observation model presenting relation between elements of the observation value and a value of the attitude so as to estimate the elements of the observation value at the second time, thereby generating an estimated observation value having the estimated elements; calculating difference between the estimated observation value and the input observation value to generate an observation residual representing the calculated difference; and generating the estimated attitude error based on the observation residual and the predicted value of the attitude of the equipment.

6. The method according to claim 1, wherein the attitude of the equipment is determined to be stable in case that an absolute value of difference between a magnitude of the acceleration data outputted from the acceleration sensor and a magnitude of the gravity acceleration is not more than a predetermined value.

7. A method of estimating attitude of equipment having a sensor, comprising:
generating a first estimation value of the attitude of the equipment at a first time;
predicting the attitude of the equipment at a second time after a predetermined period from the first time to thereby generate a predicted value of the attitude, by applying the first estimation value to a state transition model indicating transition of the attitude of the equipment;
estimating a difference between the predicted value of the attitude and a true value of the attitude of the equipment based on data outputted from the sensor to thereby generate an estimated attitude error between the predicted attitude and true attitude of the equipment;
extracting a specific attitude component from a plurality of attitude components of the estimated attitude error; and
calculating a second estimation value of the attitude of the equipment at the second time based on the predicted value of the attitude and the specific attitude component extracted from the estimated attitude error.

8. The method according to claim 7, wherein the sensor comprises a magnetic sensor for outputting magnetic data representing geomagnetism.

9. The method according to claim 7, wherein the plurality of attitude components of the estimated attitude error comprise a tilt component representing a tilt from an axis extending in a direction of gravity acceleration and a rotation component around the axis, and the specific attitude component is the rotation component obtained by removing the tilt component from the estimated attitude error.

10. The method according to claim 7, wherein the plurality of attitude components are obtained by changing reference attitude of the equipment by the estimated attitude error.

11. An apparatus for estimating attitude of equipment having a plurality of sensors including an acceleration sensor, the apparatus comprising one or more processor configured to:
generate a first estimation value of the attitude of the equipment at a first time;
determine whether the attitude of the equipment is stable or not, based on acceleration data outputted from the acceleration sensor;
predict the attitude of the equipment at a second time after a predetermined period from the first time to thereby generate a predicted value of the attitude, by applying the first estimation value to a state transition model indicating transition of the attitude of the equipment;
estimate a difference between the predicted value of the attitude and a true value of the attitude of the equipment based on data outputted from at least one sensor included in the plurality of the sensors to thereby generate an estimated attitude error between the predicted attitude and true attitude of the equipment;
calculate a second estimation value of the attitude of the equipment at the second time based on the predicted value of the attitude and the estimated attitude error when the attitude of the equipment is determined to be stable;
extract a specific attitude component from a plurality of attitude components of the estimated attitude error when the attitude of the equipment is determined to be not stable; and
calculate a second estimation value of the attitude of the equipment at the second time based on the predicted value of the attitude and the specific attitude component extracted from the estimated attitude error when the attitude of the equipment is determined to be not stable.

12. An apparatus for estimating attitude of equipment having a sensor, the apparatus comprising one or more processor configured to:
generate a first estimation value of the attitude of the equipment at a first time;
predict the attitude of the equipment at a second time after a predetermined period from the first time to thereby generate a predicted value of the attitude, by applying the first estimation value to a state transition model indicating transition of the attitude of the equipment;
estimate a difference between the predicted value of the attitude and a true value of the attitude of the equipment based on data outputted from the sensor to thereby generate an estimated attitude error between the predicted attitude and true attitude of the equipment;
extract a specific attitude component from a plurality of attitude components of the estimated attitude error; and
calculate a second estimation value of the attitude of the equipment at the second time based on the predicted value of the attitude and the specific attitude component extracted from the estimated attitude error.
